(19) United States
(12) Patent Application Publication
(10) Pub. No.: US 2009/0284098 A1
(43) Pub. Date: Nov. 19, 2009

(54) Brushholder Mount for Contact Brushes of a Commutator Machine

(76) Inventor: Helmut Sesselmann, Steinach (DE)

Correspondence Address: CHRISTIE, PARKER & HALE, LLP, PO BOX 7068, PASADENA, CA, 91109-7068, US

(21) Appl. No.: 12/224,754

(22) PCT Filed: Mar. 1, 2007
(86) PCT No.: PCT/EP2007/001882

§ 371 Date: Dec. 16, 2008

(30) Foreign Application Priority Data
Mar. 6, 2006 (DE) 202006003

(51) Int. Cl. H01R 39/38; H02K 13/00

(52) U.S. Cl. 310/242

(57) ABSTRACT

A brushholder mount for contact brushes of a commutator machine is provided. The brushholder mount having spring elements which have brush shoes (which are connected to the contact brushes), carry the contact brush current and prestress the contact brushes in the direction of the commutator of the commutator machine. The spring elements are connected to at least one further elastic element.

### CROSS-REFERENCE TO A RELATED APPLICATION

This application is a National Phase patent application of International Patent Application Number PCT/EP2007/001882, filed on Mar. 1, 2007, which claims priority of German Utility Model Application Number 20 2006 003 747.0, filed on Mar. 6, 2006.

### BACKGROUND

The invention relates to a brushholder mount for contact brushes of a commutator machine.

In order to hold and guide contact brushes of a commutator machine, brushholder mounts are known which comprise a mounting frame which is matched to the contact brushes and into which the contact brushes are inserted, with the brushholder mounts being arranged such that they can be moved in the longitudinal direction of the mounting frame, which is in the form of a frame for readjustment, are prestressed in the direction of the commutator by means of a compression spring which rests on the rear face (facing away from the commutator) of the contact brushes, and are fed with the armature current. A simpler and more cost-effective solution for a brushholder mount comprises spring elements, in particular leaf springs, which by their shape and natural spring characteristics ensure the required prestressing of the contact brushes, and supply the current to the contact brushes.

WO 03/032 468 A1 discloses a brushholding system for an electrical drive device, which brushholding system contains a brushholding plate with a central aperture for holding a commutator, and leaf springs which are arranged on the brushholding plate, each have one brush, carry the brush current, and prestress the brushes in the direction of the commutator. In a side view, the leaf springs are U-shaped, in which case the free end of one limb carries the brush, which is arranged on the leaf spring directly or via a brushholder, and the other end of the leaf spring can be inserted into the brushholding plate, at right angles to it.

In order to avoid the brush springs together with the brushes starting to oscillate slightly during operation of the drive device, causing disturbing noise, the brushholding plate of the known brushholding system has guide means for guidance of the brushes or of those brush sections of the leaf springs which hold the brushes, in the radial direction. By absorbing lateral forces, the aim of the guide means is to prevent the brushes or brush sections of the leaf springs from being able to move in the rotation direction of the commutator, so that free oscillation of those ends of the leaf springs to which the brushes are fitted is suppressed, thus reducing the amount of noise developed and originating from the leaf springs during operation of the drive device.

### SUMMARY

Against the background of the known brushholding system, the subject matter of the present invention is based on the object of preventing or effectively suppressing oscillations of the brushholder mount and therefore the occurrence of disturbing noise, using simple means which can be produced and used at low cost.

The exemplary solution according to an exemplary embodiment of the invention prevents or suppresses oscillations in particular at the commutator frequency or brush noise frequency, and therefore the occurrence of disturbing noise, using simple means which can be produced and can be used at low cost. In this case, the material, the structure, the arrangement and the connection of the elastic element to the spring elements can be varied over a wide range, and can be matched to the respective conditions.

Suitable choice of material for the elastic element provides the capability to adjust the spring constants of the elastic element, and therefore the degree of damping.

The elastic element is exemplary composed of an electrically insulating material, connects the spring elements and prestresses them in the direction of the commutator, so that, on the one hand, the contact pressure of the contact brushes on the commutator is increased, and on the other hand this results in increased damping of the spring elements.

A first exemplary variant of the embodiment and arrangement of the elastic element comprises a prestressing element which connects those limbs of the spring elements which carry the contact brush current to one another.

In a second exemplary variant, which can also be combined with the first variant, spring arms, which project beyond the brush shoes of the spring elements are connected to the elastic element.

In the second exemplary variant, the spring arms of the spring elements are supported on contact areas of the elastic element such that the degree of damping can be adjusted by the nature and form of the contact of the spring arms on the elastic element, while maintaining an essentially free choice for the shape of the spring arms and the material, as well as the shape of the elastic element.

In a further exemplary refinement of the solution according to an exemplary embodiment of the invention, the elastic element prestresses the spring elements in the direction of the commutator, and therefore, in addition to the connection of the spring elements to the commutator machine and the shaping of the spring elements, ensures that the contact brushes make a firm contact with the segmented surface of the commutator.

Angling of the ends of the spring arms forms a supporting surface for the spring arms on the elastic element, whose size and shape can be used to adjust the extent of the oscillation damping, while at the same time ensuring the prestressing and readjustment of the spring elements in the direction of the commutator.

In one exemplary embodiment, the elastic element comprises a strip whose strip ends are clamped in on the pole tube of the commutator machine.

The use of a strip for the elastic element allows the strip, which is composed of an elastomer, plastic, combined elastomer and plastic strip or a steel strip preferably extrusion coated with plastic, to be produced at low cost by extrusion. In this case, the interlocking connection of the strip to the brushholder mount on the one hand allows the strip to be matched to the shape and dimension of the spring elements and on the other hand allows simple replacement when the contact brushes are replaced, as well as suppression of the transmission of structure-borne sound from the strip to the brushholder mount.

Furthermore, the use of a strip for the elastic element allows additional tolerance compensation, and the choice of material and composition as well as the size of the strip allows the spring constants of the strip, and therefore the degree of damping, to be adjusted. Both the cross-sectional area and the cross-sectional shape of the strip can in this case be matched to the desired damping behavior.

The length of the spring arms and of the strip is designed, and the strip ends are connected to the brushholder mount, such that the strip ends are inclined at an acute angle to the horizontal.

The inclination of the strip ends and the horizontal profile of the strip between the ends of the spring arms, which are at a distance from one another, result in a strip bend which provides additional support and prestressing for the spring elements in the direction of the commutator.

Furthermore, the intensity of the oscillation damping can be adjusted by fixing the angle between the strip ends and the horizontal, the mutual separation between the supporting surfaces of the spring elements, the spring force of the strip and/or the height of the supporting surfaces of the spring elements on the strip, with respect to the connection of the strip to the brushholder mount.

Corrugated or zigzag profiling, in particular, of the contact areas of the strip counteracts the free ends of the spring elements pivoting away against the prestressing of the spring elements in the direction of the commutator, thus ensuring a predetermined contact pressure of the contact brushes on the commutator.

The formation of the profiling of the strip as readjustment catches, which counteract displacement of the supporting surfaces of the spring elements against the prestressing of the contact brushes, with the readjustment catches preferably having a sawtooth profile with a different flank inclination, whose more sharply inclined flanks are directed toward the center longitudinal axis of the brushholder mount, not only counteracts the free ends of the spring elements pivoting away against the contact pressure direction of the contact brushes, but at the same time results in readjustment of the spring elements and therefore of the contact brushes in the direction of the commutator as the brushes wear away.

In addition, metal brackets can be inserted into the strip, for example by spraying, in the contact areas of the strip with the ends of the spring arms, thus increasing the thermal load capability of the strip.

An elastic supporting element can be arranged between the brushholder mount and that side of the strip which faces away from the commutator in order to make the strip section which runs between the free ends of the spring elements robust.

In order to simplify production and to save connecting lines, as well as to provide an arrangement which saves space, the limbs of the spring elements are connected to a circuit board for controlling the commutator machine.

In order to increase the prestressing of the spring elements in the direction of the commutator, the limbs of the spring elements have bend sections which are directed toward one another, in which longitudinal slots are arranged in order to hold the prestressing element, which is in the form of a rod, connects the limbs to one another and thus additionally prestresses them and damps oscillations.

### BRIEF DESCRIPTION OF THE DRAWINGS

The idea on which the invention is based will be explained in more detail with reference to one exemplary embodiment, which is illustrated in the figures, in which:

FIG. 1 shows a perspective illustration of the pole tube of a commutator machine, of a commutator and of a brushholder mount connected to a circuit board, with leaf springs supported on an oscillation damping strip.

FIG. 2 shows a perspective illustration, as in FIG. 1, with a prestressing and damping element inserted into longitudinal slots in the spring limbs of the spring elements.

FIG. 3 shows a schematic-perspective cross section through the pole tube of the commutator machine, the commutator and the brushholder mount, with leaf springs supported on the oscillation damping strip and with an additional supporting element.

FIG. 4 shows a schematic-perspective illustration of one variant of the ends of the spring arms of the leaf springs.

FIG. 5a shows the oscillation damping strip as shown in FIGS. 1 to 3 with corrugated profiling.

FIG. 5b shows the oscillation damping strip as shown in FIGS. 1 to 3 with zigzag profiling.

FIG. 5c shows the oscillation damping strip as shown in FIGS. 1 to 3 with sawtooth profiling.

### DETAILED DESCRIPTION

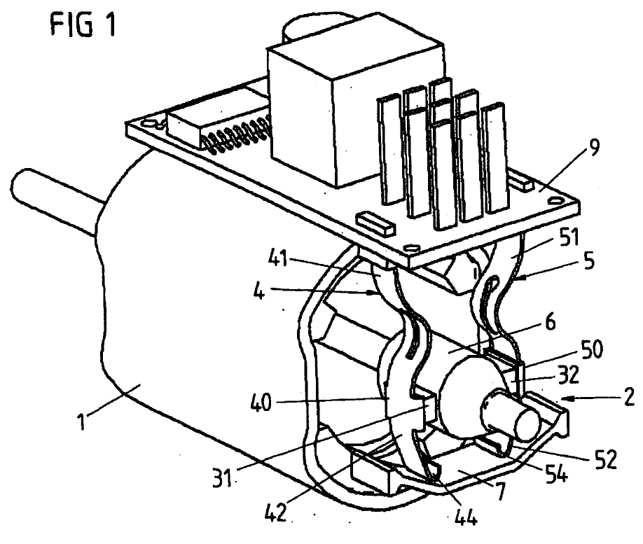

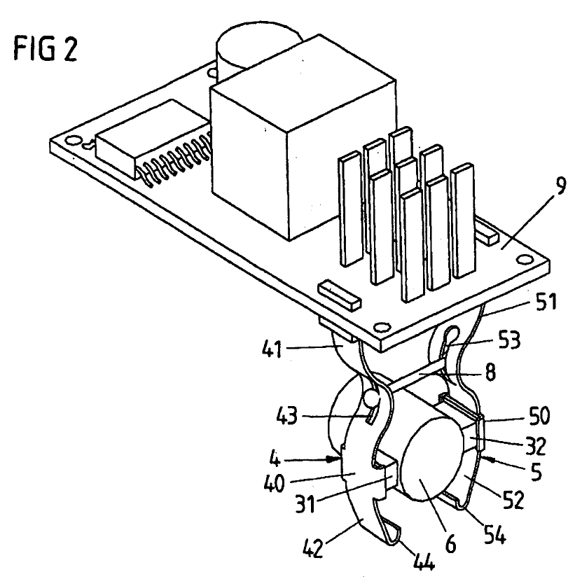

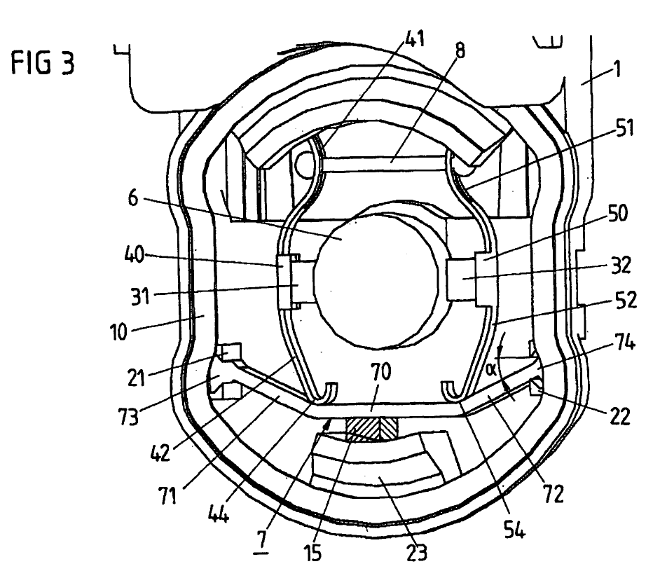

FIGS. 1 to 3 show a schematic-perspective view and a cross section of a commutator machine 1 with a pole tube 10, a commutator 6 which is connected to the armature of the commutator machine 1, and a brushholder mount 2. Two contact brushes 31, 32 rest on the commutator segments or webs, are arranged diametrically opposite one another, are held by two spring elements 4, 5 in the form of leaf springs, and are prestressed in the direction of the commutator 6 such that they rest on the commutator segments with a predetermined contact pressure. The limbs 41, 51 of the spring elements 4, 5 are connected to a circuit board 9 in order to control the commutator machine 1, and carry the armature current to the contact brushes 31, 32, which are connected to the spring elements 4, 5 via brush shoes 40, 50.

During operation of the commutator machine 1, that is to say when the commutator 6 is rotating, the contact brushes 31, 32 slide on the commutator segments or commutator webs, and are caused to oscillate in the process. In the oscillating system that is formed from the contact brushes 31, 32 and the spring elements 4, 5, the formation of a plurality of resonance points, which occur at the commutator frequency or brush noise frequency, is particularly disadvantageous since they amplify the oscillations caused by the contact of the contact brushes with the commutator segments and, via the connection of the spring elements to the brushholder mount, lead to significantly disturbing brush noise or commutation noise. The measures described in the following text are used to suppress or to reduce the oscillations caused by the oscillating system comprising the contact brushes 31, 32 and the spring elements 4, 5, which are in the form of leaf springs.

A first variant for damping the oscillations that are caused by the oscillating system comprising the contact brushes 31, 32 and the spring elements 4, 5, which are in the form of leaf springs, and for additionally increasing the contact pressure of the contact brushes 31, 32 on the commutator 6 comprises the limbs 41, 51 of the spring elements 4, 5 being provided with bend sections which are directed toward one another and in the prestressing direction, and have longitudinal slots 43, 53 into which a prestressing and damping element 8, which is in the form of a rod and is composed of electrically insulating material, is inserted, connecting the limbs 41, 51 of the spring elements 4, 5 to one another and in consequence not only providing prestressing in a sprung manner in the prestressing direction, that is to say in the direction of the commutator 6, but also providing damping for oscillations. In order to insert the prestressing and damping element 8 into the longitudinal slots 43, 53 in the limbs 41, 51, these have an enlarged cutout at one end, through which the thickened ends of the prestressing and damping element 8, which is in the form of a rod, can be plugged. Movement of the prestressing and damping element 8 to the point where the limbs 41, 51 are closest together results in the thickened ends of the prestressing and damping element 8, which is in the form of a rod, resting in an interlocking manner on the outer faces of the limbs 41, 51, pointing away from the commutator.

Alternatively, the spring elements 4, 5 have spring arms 42, 52 which are lengthened beyond the brush shoes 40, 50 and have angled ends 44, 54 which are supported on an elastic element, which is in the form of an oscillation damping strip 7 and damps or eliminates the oscillations, which are amplified by the oscillating system comprising the spring elements 4, 5, brush shoes 40, 50 and contact brushes 31, 32, possibly in addition to the prestressing and damping element.

The oscillation damping strip 7 is clamped into holding elements 21, 22 on the sides of the pole tube 10 of the commutator machine 1, which holding elements 21, 22 are arranged, taking into account the length of the strip 7, such that the strip 7 is angled at the points or areas where it touches the ends 44, 54 of the spring arms 42, 52 of the spring elements 4, 5. In consequence, the strip 7 has two obliquely running strip ends 71, 72, and a central section 70 which runs horizontally between the angled ends 42, 52 of the spring arms 42, 52.

This profile of the strip 7 and the spring arms 42, 52 (which are aligned, starting from the brush shoes 40, 50, with their ends 44, 54 with respect to the center longitudinal axis of the brushholder mount 2 or commutator 6) result in the spring arms 42, 52 of the spring elements 4, 5 additionally being prestressed toward the center longitudinal axis of the brushholder mount 2, and therefore in the contact brushes 31, 32 being pressed more strongly against the commutator 6, with the shape of the spring elements 4, 5 in conjunction with the profile and the surface configuration of the strip 7, as well as the shape of the ends 44, 54 of the spring arms 42, 52, resulting in the spring elements 4, 5 being damped outward, that is to say directed away from the center longitudinal axis of the brushholder mount 2, as well as free movement toward the center longitudinal axis.

In this case, the angle α which the strip ends 71, 72 of the strip 7 include with the horizontal, and which thus represents a measure of the angle of the strip 7, in conjunction with the spring force of the strip 7 and the contact area of the ends 44, 54 of the spring arms 42, 52 on the strip 7 governs the intensity of the oscillation damping. The extent of the damping for a predetermined configuration of the oscillating system comprising the commutator 6, contact brushes 31, 32 and spring elements 4, 5 can thus be adjusted by adjustment of the spring constants of the strip 7, by variation of the angle α and by varying the size and nature of the contact surface of the ends 44, 54 of the spring arms 42, 52 on the strip 7. In this case, the strip 7 at the same time allows tolerance compensation for the arrangement and the size of the brushholder 2, and of the elements of the brushholder 2.

In addition, a metal bracket can be inserted on the surfaces where the spring elements 4, 5 touch the strip 7, increasing the thermal resistance of the strip 7 as a consequence of the heating of the contact brushes 31, 32 and of the spring elements 4, 5.

By way of example, the strip 7 is produced from an elastomer, from plastic or from a combination of an elastomer and a plastic, or is formed, and in particular extruded, as a steel strip preferably extrusion coated with plastic. The strip 7 is connected to the brushholder mount 2 by an interlock between wedge-shaped attachment parts 73, 74, which are arranged at the strip ends 71, 72, and attachment holders 21, 22, which are arranged on the side surfaces of the pole tube 10, with a mutually opposite accommodation profile, that is to say with a recess similar to a dovetail.

In order to support the central, horizontal section 70 of the strip 7, a preferably elastic supporting element 15 can be arranged between that surface of the central section 70 of the strip 7 which faces away from the commutator 6, and a projection 23 which is provided on the inner face of the pole tube 10.

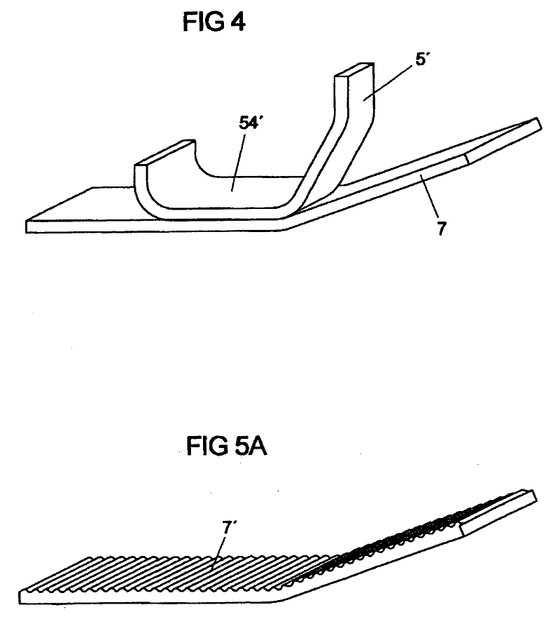

The ends 44, 45 of the spring arms 42, 52 of the spring elements 4, 5 may be shaped as required, in particular being in the form illustrated in FIGS. 1 to 3, or as ends 54′ with a broad contact area of a spring element 5′ in the configuration shown in FIG. 4, in order to make contact with the strip 7.

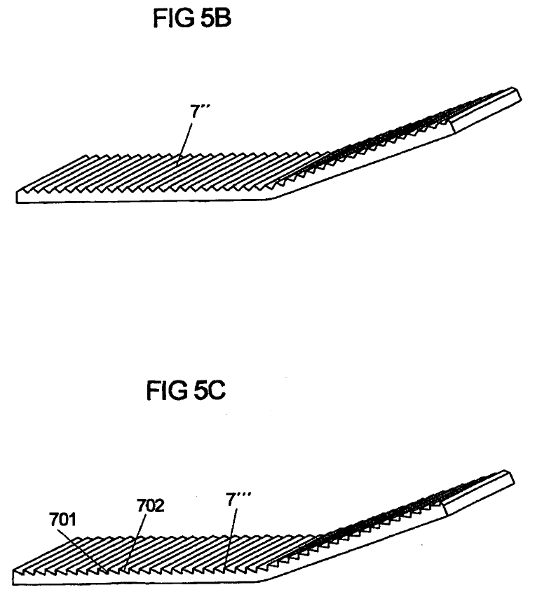

In order to prevent the spring arms 42, 52 of the spring elements 4, 5 from pivoting away during operation of the commutator machine, that surface of the strip 7 which faces the commutator 6 is provided with profiling. FIG. 5a shows a strip 7′ with corrugated profiling, and FIG. 5b shows a strip 7″ with zigzag profiling.

In a further embodiment, which is illustrated schematically in FIG. 5c, the surface of a strip 7′″ is provided with a sawtooth structure, with the steeply falling flanks 701 of the sawtooth strip 7′″ facing the center longitudinal axis of the brushholder mount 2, while the flanks 702 which fall at a shallow angle are in the opposite direction. The sawtooth profile shown in FIG. 5c provides a readjustment catch for the spring elements 4, 5 as the contact brushes 31, 32 wear away, and when excessive oscillations, and corresponding movement of the spring elements 4, 5 directed toward the center longitudinal axis occur.

1-21. (canceled)

22. A brushholder mount for contact brushes of a commutator machine comprising spring elements having brush shoes connected to the contact brushes, wherein the spring elements carry a contact brush current and prestress the contact brushes in a direction of a commutator of the commutator machine, and wherein the spring elements are connected to at least one further elastic element.

23. The brushholder mount according to claim 22, wherein the elastic element is composed of an electrically insulating material, connects the spring elements to one another and prestresses the spring elements in the direction of the commutator.

24. The brushholder mount according to claim 23, wherein the elastic element comprises a prestressing and damping element connecting limbs of the spring elements to one another wherein the limbs carry the contact brush current.

25. The brushholder mount according to claim 23, wherein spring arms of the spring elements project beyond the brush shoes and are connected to the elastic element.

26. The brushholder mount according to claim 25, wherein the spring arms of the spring elements are supported on contact areas of the elastic element.

27. The brushholder mount according to claim 26, wherein ends of the spring arms of the spring elements are angled to form a supporting surface on the elastic element.

28. The brushholder mount according to claim 22, wherein the elastic element is composed of an oscillation damping strip having ends clamped in on a pole tube of the commutator machine.

29. The brushholder mount according to claim 28, wherein a length of the spring arms and a length of the oscillation damping strip are configured, and the strip ends are connected to the pole tube, such that the strip ends are inclined at an acute angle to the horizontal.

30. The brushholder mount according to claim 29, wherein at least one of the angle of the strip ends to the horizontal, a distance between the angled ends of the spring arms and the height of the angled ends of the spring arms on the oscillation damping strip is adjusted with respect to the connection of the oscillation damping strip to the pole tube.

31. The brushholder mount according to claim 28, wherein the strip ends are inserted in an interlocking manner into holding elements of the pole tube.

32. The brushholder mount according to claim 28, wherein at least contact areas of the strip which hold the ends of the spring arms are profiled.

33. The brushholder mount according to claim 28, wherein a profile of contact areas of the oscillation damping strip is a corrugated or a zigzag profile.

34. The brushholder mount according to claim 32, wherein a profile of the contact areas of the oscillation damping strip comprises re-adjustment catches counteracting displacement of supporting surfaces of the spring elements against the prestressing of the contact brushes.

35. The brushholder mount according to claim 34, wherein the re-adjustment catches have a sawtooth profile with a different flank inclination, wherein more sharply inclined flanks are directed toward a center longitudinal axis of the brushholder mount.

36. The brushholder mount according to claim 28, wherein the oscillation damping strip is one of an elastomer strip, a plastic strip or a combined elastomer and plastic strip.

37. The brushholder mount according to claim 28, wherein the oscillation damping strip is in the form of a steel strip.

38. The brushholder mount according to claim 28, further comprising an elastic supporting element arranged between the brushholder mount and a side of the oscillation damping strip facing away from the commutator.

39. The brushholder mount according to claim 24, wherein the limbs of the spring elements are connected to an electrical circuit board.

40. The brushholder mount according to claim 24, wherein the prestressing and damping element is in the form of a rod and is inserted into longitudinal slots in the limbs of the spring elements.

41. The brushholder mount according to claim 40, wherein the prestressing and damping element is in the form of a rod, and wherein the limbs of the spring elements have bend sections directed toward one another and in which the longitudinal slots are arranged in order to hold the prestressing and damping element.

42. The brushholder mount according to claim 22, wherein the spring elements are formed from leaf springs.

43. The brushholder mount according to claim 37, wherein the steel strip is extrusion coated with plastic.
